(19) United States
(12) Patent Application Publication
(10) Pub. No.: US 2016/0125460 A1
(43) Pub. Date: May 5, 2016

(54) METHOD AND APPARATUS FOR MANAGING PURCHASE TRANSACTIONS

(71) Applicants: AT&T Intellectual Property I, LP, Atlanta, GA (US); AT&T Mobility II LLC, Atlanta, GA (US)

(72) Inventors: Sam Zellner, Atlanta, GA (US); Jeffrey Mikan, Atlanta, GA (US); Jeff Pedro, Alpharetta, GA (US)

(21) Appl. No.: 14/529,630

(22) Filed: Oct. 31, 2014

(51) Int. Cl. G06Q 30/02; G06Q 20/40; G06Q 30/06

(52) U.S. Cl. CPC G06Q 30/0255; G06Q 30/0631; G06Q 30/0269; G06Q 30/0637; G06Q 20/405

(57) ABSTRACT

Aspects of the subject disclosure may include, for example, obtaining user data of a user, receiving a group of offers for products, analyzing the user data to generate purchase criteria, selecting an offer for a product from among the group of offers for the products according to the purchase criteria, negotiating a purchase of the product according to the purchase criteria, determining a recommendation associated with the purchase of the product based on the negotiating, presenting the recommendation, obtaining an authorization for the purchase of the product in response to the recommendation, and communicating with a server to complete a purchase transaction for the product in response to the authorization. Other embodiments are disclosed.

### FIELD OF THE DISCLOSURE

The subject disclosure relates to a method and apparatus for managing purchase transactions.

### BACKGROUND

Retail environments are often directed to the general public without being tailored to each customer. Advertisements are often created to also be directed to broad audiences. Targeted marketing is often generalized to demographic groupings. Often, each retailer is forced to re-learn information about each customer that can be utilized to assist in a product sale.

Purchasing a product can be a time-consuming event based on many variables. Often, purchasing decisions are not made based on all of the available information related to the product.

### BRIEF DESCRIPTION OF THE DRAWINGS

Reference will now be made to the accompanying drawings, which are not necessarily drawn to scale, and wherein:

FIGS. 1 and 2 depict illustrative embodiments of systems that facilitate purchase transactions according to obtaining user data;

FIGS. 3 and 4 depict illustrative embodiments of methods used in portions of the system described in FIG. 2;

FIGS. 5-6 depict illustrative embodiments of methods used in portions of the systems described in FIGS. 1 and 2;

FIG. 7 depicts an illustrative embodiment of a communication system that provides media services and facilitates product and service purchases;

FIG. 8 depicts an illustrative embodiment of a communication device; and

FIG. 9 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments for facilitating a purchase transaction. One or more aspects of the subject disclosure include an intelligent and automated request-based purchasing bot that provides consumer product customers with a virtual companion that knows his or her lifestyle in order to engage as a trusted advisor to the customer. In some embodiments, the bot can act on the customer's behalf without direct human interaction while in other embodiments the bot can obtain authorization from the customer prior to completion of the transaction. In one or more embodiments, the bot can run on one or more communication devices of the user. The bot can collect data associated with the user, can understand the user's habits and/or preferences, and can also understanding the user's financial goals and/or spending ability. The bot can be a processor of data, communicating with other bots representing retailers in order to broker transactions that may be mutually beneficial to the retailer and user. The bot can also be a reliable source of information about transactions.

In one or more embodiments, the bot can be configured into different functional areas including inputs (e.g., data collection), processing (e.g., arriving at conclusions) and outputs (e.g., human and bot-to-bot interactions). As inputs into the Bot, user data can be collected that is relevant to purchasing decisions. The bot can engage with the user directly and/or indirectly, providing an opportunity to create and maintain a profile of preferences, likes, dislikes, and general demographic information. The bot can engage with the customer on financial information, to include knowing available credit of credit line accounts and bank accounts, personal budget status and goals, as well as habitual spending trends. This information can also be obtained, with the permission of the user, from other sources, such as banks, credit card entities, and so forth. User information can be public, private and/or camouflaged preferences as well. As an additional form of data collection, the bot can receive offers from merchants, e.g., offers that merchants want the bot to consider pushing through to the decision-making process.

The bot can receive updates from the customer's other smart appliances, such as automobiles that generate requests for service or repair, or refrigerators that generate requests for maintenance or to restock perishable goods. The bot can process the data collected and arrive at one or more conclusions, which form interactions with the user and/or with other bots. Business rules driven by combinations of data points can inform opportunities to: reactively filter inbound targeted offers, proactively search retailer bots for desired goods and services, negotiate deals with retailer bots, arrive at purchase decisions, arrive at decline to purchase decisions, and arrive at requests for authorization decisions. In one or more embodiments, the bot can, on the customer's behalf and based upon the business rules defined by the customer, be permitted to conclude transactions with seller bots. The bot can proactively make purchases from retailer bots and can deliver recommended products for purchase to the customer for human-driven decisions. The bot can keep the customer informed of the status of purchases to include relevant successes and failures in the process.

The exemplary embodiments described herein can include one or more components and/or one or more steps described with respect to U.S. application Ser. No. ______ entitled “Method and Apparatus for Facilitating Purchase Transactions Associated with a Showroom” with Attorney Docket No. 2014-0741_7785-1107, the disclosure of which is hereby incorporated by reference.

One embodiment of the subject disclosure includes obtaining, by a communication device of a user that includes a processor, user data of the user where the user data comprises financial information of the user, user preferences of the user, and a history of purchase transactions of the user. The communication device can receive, from a server of a merchant, a group of offers for products. The offers can describe the product, suggest a price of the product and provide other information relevant to a product purchase. The communication device can analyze the user data to generate purchase criteria. The communication device can select an offer for a product from among the group of offers for the products according to the purchase criteria. The communication device can negotiate, with the server via an exchange of communications, a purchase of the product, where the negotiating by the communication device is according to the purchase criteria. The communication device can determine a recommendation associated with the purchase of the product based on the negotiating. The communication device can present the recommendation and can obtain an authorization for the purchase of the product in response to the recommendation. The communication device can communicate with the server to complete a purchase transaction for the product in response to the authorization.

One embodiment of the subject disclosure includes a server having a processor and a memory that stores executable instructions that, when executed by the processor, facilitate performance of operations. The server can detect a communication device of a user in a showroom. The server, responsive to the detecting, can receive, from the communication device, user preferences of the user and a history of purchase transactions of the user. The server can select a group of offers for products from among a plurality of offers for a plurality of products according to the user preferences and the history of purchase transactions. The server can determine an availability for the products. The server can provide, to the communication device, the group of offers for the products according to the availability. The server can receive, from the communication device, a selection message indicating an offer for a product that was selected by the communication device from among the group of offers for the products. The server can negotiate, with the communication device via an exchange of communications, a purchase of the product. The server can communicate, with the communication device, to complete a purchase transaction for the product.

One embodiment of the subject disclosure includes a machine-readable storage device, comprising executable instructions that, when executed by a processor of a communication device of a user, facilitate performance of operations. The processor can obtain user data of the user, where the user data comprises financial information of the user, user preferences of the user, and a history of purchase transactions of the user. The processor can receive a plurality of advertisements and can select a group of advertisements from among the plurality of advertisements according to the user data. The processor can store the group of advertisements and deleting non-selected advertisements of the plurality of advertisements and can analyze the user data to generate advertisement criteria. The processor can monitor user activity at the communication device and can determine target user activity according to the monitoring of the user activity. The processor can select a target advertisement from among the group of advertisements according to the advertisement criteria and the target user activity. The processor can present the target advertisement during the target user activity.

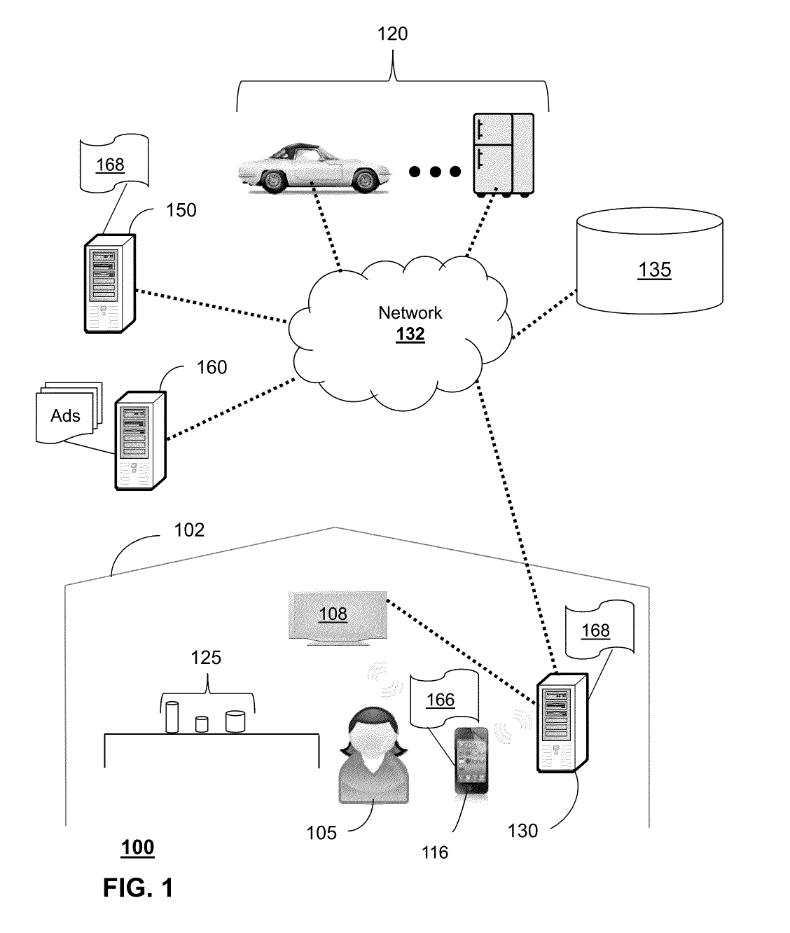

FIG. 1 depicts an illustrative embodiment of a system 100 that facilitates purchase transactions through use of bots 166 and 168 executed by computing devices. The purchase transactions can be at a showroom 102 and/or via a website such as managed by an online merchant server 150. Showroom 102 can be any location that allows users (one of which is illustrated as user 105) to view or otherwise access products 125, such as a store, a car dealership, an appliance service center and so forth. The type of product 125 can vary including electronic products (e.g., a mobile phone, a tablet, a television, software, a home appliance, and so forth) and non-electronic products (e.g., tools, furniture, consumer goods, perishable items including food, and so forth). Products 125 can also include service(s) that can be purchased with or without purchasing a physical product. For instance, the product 125 can be a repair service to be performed at a repair center (which can be the showroom 102 in FIG. 1) for an appliance or other object of the user which is denoted by reference 120. The particular appliance or object of the user can vary and can include a car, refrigerator, television, washing machine, air conditioner or other item which is capable of communication as will be further described herein.

User 105 can have one or more communication devices 116 (which is depicted in FIG. 1 as a mobile device but can also be other types of communication devices including a vehicle communication device, a set top box, a desktop computer, a laptop computer, a tablet, and so forth). The communication device 116 can execute the bot 166, which can collect or otherwise obtain user data, interact with other bots or humans with respect to a product purchase according to the user data, and which can complete a purchase transaction with or without user intervention. The bot 166 is depicted as being resident on the communication device 116, but the exemplary embodiments can include a distributed system in which the bot 166 is resident on a number of different communication devices 116. For example, the bot 166 of communication device 116 can perform the function of interacting with sales bots or human sales agents, while other bots of the user perform other functions, such as collecting user data and providing interaction data to the bot 166 so that the bot 166 can negotiate with the sales bot or the human sales agent.

In one embodiment, the user preferences can be based on user input such as in a user profile or can be indirectly determined, such as based on monitoring user activity including media consumption, calendar events, online social network activity, and so forth. The transaction history of the user can be obtained from various sources such as records of the showroom 102, records of other showrooms, and/or from other sales sources. The user data can include other information such as demographics of the user. The obtaining of the user data can be performed in conjunction with authorization received from the user, such as a user that permits the bot 166 to obtain this data whenever the user is seeking to purchase a product 125 at the showroom 102 or elsewhere. The user data can also be obtained over a network 132 from various sources including a database 135. The sources can be managed by the same entity managing the server 130 and/or can be managed by other entities that are different from the entity managing the server 130.

In one embodiment, the server 130, which is associated with the showroom 102, can be located at the showroom 102 or can be located elsewhere, such as in the cloud. A single server 130 is illustrated but any number of servers can be utilized in association with any number of showrooms 102. In one or more embodiments, the server 130 can perform a number of functions to facilitate purchasing of product(s) by the bot 166 of the user's communication device 116. For instance, the server 130 can perform, via bot 168, one or more of detecting the communication device 116 of the user 105 in the showroom 102; receiving, from the communication device, user data such as user preferences, a history of purchase transactions, and/or a history of media consumption (e.g., responsive to the detecting); selecting a group of offers for products from among a plurality of offers for a plurality of products according to the user data (e.g., according to the user preferences and the history of purchase transactions); determining an availability for the products; providing, to the communication device, the group of offers for the products (e.g., according to the availability); receiving, from the communication device, a selection message indicating an offer for a product that was selected by the communication device from among the group of offers for the products; negotiating, with the communication device via an exchange of communications, a purchase of the product; and/or communicating, with the communication device, to complete a purchase transaction for the product. In another embodiment, the bot 168 can be a distributed bot where some of the selling functions are performed by the bot 168 located at the showroom 102 and other functions associated with the sales are performed by a remote computing device.

In one or more embodiments, the server 130 can select a group of services from among a plurality of services associated with the product, such as according to the user preferences and the history of purchase transactions. The server can provide, to the communication device 116, offers for the group of services. In this example, the selection message can indicate a service that was selected by the communication device 116 from among the group of services, and the negotiating can be associated with a purchase of the service. The server 130 can further communicate with the communication device 116 to complete a purchase transaction for the service.

In one or more embodiments, in response to a completion of the purchase transaction of the product, the server 130 can delete the user data of user 105 such as user preferences and the history of purchase transactions. In one or more embodiments, the server 130 can detect that the purchase transaction for the product has not been completed; and, in response to the purchase transaction not being completed, provide interaction data descriptive of the purchase transaction to a second server (e.g., server 150) that manages a website of an online merchant selling the product. In one embodiment, the online merchant can be different from an entity managing the showroom 102. In another embodiment, the website and the showroom 102 can be managed by the same entity. In one or more embodiments, the server 130 can receive revenue sharing from the online merchant responsive to a purchase of the product by the user from the online merchant.

In one or more embodiments, a display device 108 can present information associated with the selected product, such as where the user 105 is actively participating in the negotiation or where the user is deciding whether to authorize the purchase of the product that has been negotiated between the bot 166 of the communication device 116 and the bot 168 of the server 130. The product information can be of various types including specifications for the product, consumer reviews, a list of individuals that have also purchased the product (such as individuals that are in an online social network with the user 105), and so forth. The product information can be presented by the communication device 116, the server 130 and/or by another source in communication with the display device 108.

Bot 166 can also receive a product request which is generated by an appliance 120 or other object of the user. The product request can be for a service to be performed on the appliance 120, a replacement part for the appliance, an accessory for the appliance, or some other product (which includes services) for the appliance 120. In one embodiment, the selection of the offer for the product from among the group of offers for the products (received from the bot 168 of the server 130) can be based in part on the product request. For example, a vehicle communication system can detect that the tread on the vehicle is low and can communicate a new tire message (i.e., a product request) to the communication device 116. When the user 105 is in a store (i.e., showroom 102) that sells tires, the bot 166 can select a tire offer from the bot 168 of the server 130. In one embodiment, the bot 166 can provide the product request of the appliance 120 (or a portion thereof) to the bot 168 of the server 130 to assist the bot 168 in generating the product offers.

In one or more embodiments, the bot 166 of the communication device 116 can receive a plurality of advertisements and can select a group of advertisements from among the plurality of advertisements according to user data (e.g., financial information of the user, user preferences of the user, and/or a history of purchase transactions of the user). The bot 166 can store the group of advertisements (e.g., in a memory of the communication device 116 or in a memory device accessible to the communication device such as a digital video recorder). The bot 166 can delete non-selected advertisements of the plurality of advertisements. In this example, the bot 166 can analyze the user data to generate advertisement criteria, monitor user activity at the communication device, and determine target user activity according to the monitoring of the user activity. A target advertisement can then be selected from among the group of advertisements according to the advertisement criteria and the target user activity, which can be presented during the target user activity. As an example, the selected group of advertisements can include an advertisement for a fishing lure and an advertisement for a new movie in theatres. The bot 166 can detect the user activity at the communication device 116 of presenting a video about fishing and can present the target advertisement for the fishing lure during that video. The bot 166 can also detect the user activity at the communication device 116 of visiting websites that review restaurants and can present the target advertisement for the new movie during the website visits.

In one or more embodiments, the receiving of advertisements by the communication device 116 is in response to a determination by the advertisement server 160 or the showroom server 130 that the communication device is in the showroom 102, and the advertisements are associated with products 125 sold in the showroom.

In one or more embodiments, the user 105 can define rules of engagement for the bot 166 with respect to purchase transaction, such as requiring a bot 166 to obtain authorization before completing any purchase transactions or requiring authorization for a first particular set of transactions (e.g., defined by one or more of price, type of product, brand, and so forth) while not requiring authorization for a second particular set of transactions.

System 100 can provide for bot-to-bot interaction and relationships which, when authorized by a user, can act on behalf of the user, including for the negotiating of products. System 100 allows retailers to target advertisements to a user's bot rather than directly to the user. The bot then can determine an appropriate time to present the advertisement since the bot is more familiar with the user than the retailer. System 100 allows a user to create a bot that has a relationship with the user, and the user can control the depth of the relationship such as limiting user data accessible to the bot and/or limiting decisions that can be made by the bot.

System 100 allows a user to manage privacy between the user and the bot. System 100 allows bot-to-bot relationships to be managed by the user including limiting the information that is exchangeable between the bots. System 100 provides a bot that learns from experiences including learning from negotiating with other bots for the purchase of products. The permissions for access to user data or for performing transactions can be managed by the user. In one or more embodiments, data mining can be performed on bots to reverse engineer personas. The user can control access to this information.

System 100 provides for a purchasing bot that can interfaces with seller bots and/or retail websites. The bots can manage a user's information including bank account data, credit account data, personal budgets, user profiles, user habits, and/or user preferences. The information can also be further controlled by the user, including the user defining types of information that the bot has access to or types of information that the bot can provide to other bots. The purchasing bot can employ buying rules and criteria for negotiating with other bots. The purchasing bot can manage inbound targeted offers, such as filtering out offers that the bot determines will be undesirable to the user. The purchasing bot can negotiate with the seller bot. System 100 also provides for seller bots, which can be of a retailer or of a direct manufacturer, which negotiates with the purchasing bot. The bots are not limited to purchase transactions for physical products. The purchasing bots can also negotiate and/or complete purchase transactions for automated repairs and maintenance scheduling.

System 100 enables bot 166 to access various information associated with the user including financial data, preferences data, and/or historical data (e.g., brand loyalty, habits, calendar, habitat). Other information can be accessed to facilitate the processing of the user data by the bot 166 such as buying business rules and criteria, as well as inbound offers from merchants. Interaction between the bots can be based on purchase request elements, such as input (speech, text, data), time (now, later), type (specific, general), priority level, authority level (bot authorized, customer authorized), price limit, quantity/recurring, checking trusted friends, product origin, compatibility, type of data (public, private, camouflaged), customization and personalization.

System 100 enables the bot 166 to perform reactive processing of offers from merchants, such as via seller bot 168. For example, sellers can push offers to the purchasing bot 166 including one or more of a price, a delivery date, remaining inventory, bundle or upsell offers, or other information regarding a product that is being offered. In one embodiment, the bot 166 can engage in proactive searching out of offers from merchants, including via seller bots 168 or from online merchants. For example, the purchasing bot can share with the seller/retailer information including purchase requests, purchase history, big data of the user, and/or user preferences.

The bot 166 can perform directed searching based on offers from merchants. A wish list level of interest can be established. The immediacy of need can be conveyed. In one or more embodiments, when authorized, the bot 166 can arrive at a purchase decision. When not authorized, the bot 166 can arrive at a recommendation decision to be conveyed to the user. The bot 166 can arranges delivery or pick-up of the product. In one or more embodiments, the bot 166 can engage in negotiation for a product and can report the results of the negotiation, such as successes or failures.

In one or more embodiments, the seller bot 168 can perform unsolicited push opportunities, such as where it is aware of a newly available product and notifies a purchasing bot 166 of the product. The purchasing bot 166 can perform deliberate pulls of information. System 100 provides for informing a purchaser bot 166 of the status of goods in the consumer's world. For example, machinery can communicate to a purchasing bot such as a refrigerator transmitting a notice that it needs maintenance or repair. Containers can communicate to the purchasing bot 166 such as a garbage or a pantry transmitting a notice that it contains certain items. In one embodiment, a washing machine can communicate to the purchasing bot regarding specific clothing. In another embodiment, a vehicle can communicate to a purchasing bot 166 regarding maintenance, such as an oil change. In one embodiment, system 100 provides for customer-defined filter parameters such as public requirements, private requirements, interests, and so forth. In another embodiment, system 100 provides for other filtering such as auto-execution and/or auto-presentation others to the user.

In one or more embodiments, the bot 168 of the server 130 can determine whether a user is seeking (e.g., has an interest) to purchase the product 125 in the showroom 102, such as by monitoring the showroom, including one or more of identifying a location of the user 105 in the showroom such as in proximity to a particular product 125. The monitoring can also include detecting an activity state of a communication device 116 of the user 105. In one embodiment, the server 130 can determine particular activities occurring at the communication device 116 that is indicative of not seeking to purchase a product in the showroom 102, such as an active gaming session of the communication device 116 which would indicate that the user is not looking at products but is rather playing a video game. In another embodiment, other activities can be detected that is indicative of seeking to purchase a product 125, such as a communication session of the communication device 116 with a content source (e.g., a content download) that is related to the product, such as viewing a consumer reports website for a particular product 125 that the user is in proximity to in the showroom 102.

In one embodiment, the bot 168 of the server 130 can generate a virtual sales agent according to user data obtained for the user 105. The virtual sales agent can be based on the user or can be based on a person for whom the user is seeking to purchase the product. As an example, the bot 168 can detect that the user is seeking to purchase a television for the user's husband. This detection can be based on an analysis of various user data including knowledge of family birthdays, recent website visits by the user, and so forth. The bot 168 can generate a virtual agent with characteristics similar to the user's husband. The characteristics can be determined based on obtained user data for the user's husband, such as monitored media consumption, purchasing history, user preferences, and so forth.

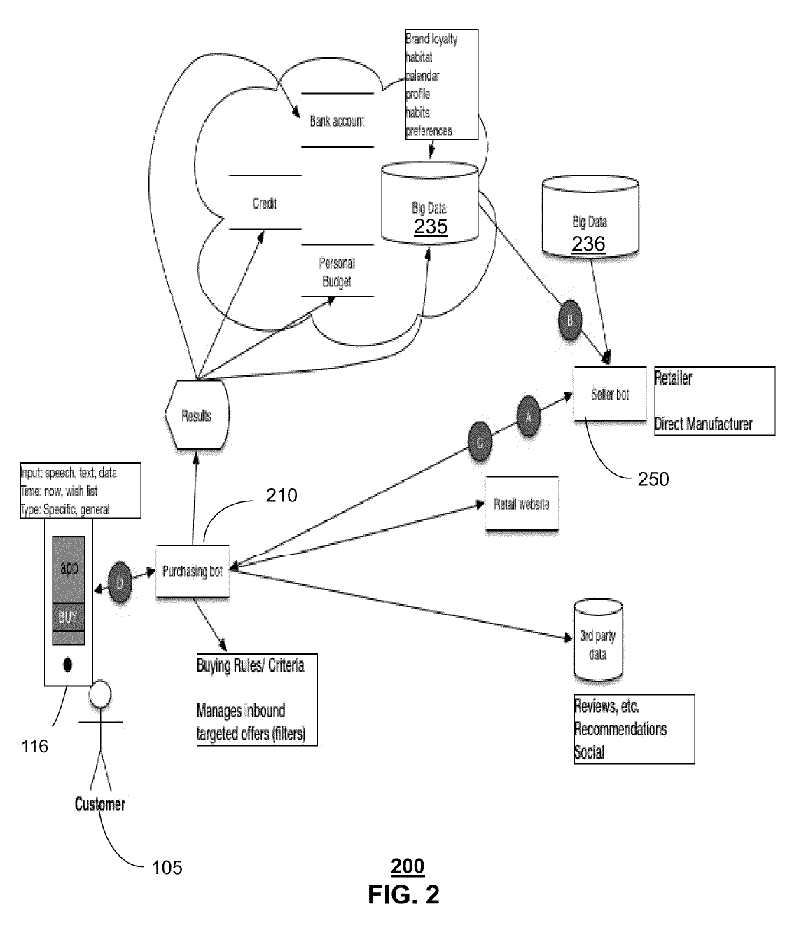

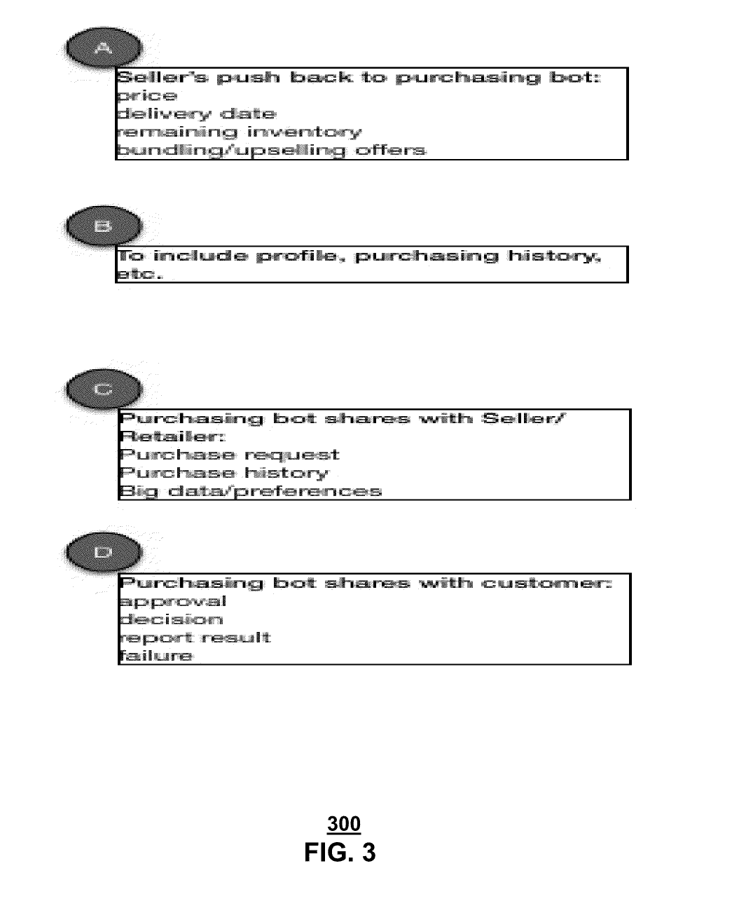

FIG. 2 illustrates a system 200 including a purchasing bot 210 and a seller bot 250. FIG. 3 illustrates a method 300 that can be carried out in system 200. At step A, the seller bot 250 can provide data to the purchasing bot 210 to facilitate a purchase of a product. For example, the data can include a product price or negotiable price range, a delivery date, remaining inventory for the product, bundling offers associated with the product, and/or upselling offers associated with the product. The seller bot 250 at step B can also obtain or otherwise retrieve information associated with the purchasing bot (and/or information associated with the user of the purchasing bot) such as a profile, a purchasing history, user preferences, and so forth.

At step C, the purchasing bot 210 can share information with the seller bot 250, such as a purchase request, a purchase history, user preferences, and/or other data monitored for the user (e.g., financial data, media consumption, social network contacts, social network likes/dislikes for various products).

At step D, the purchasing bot 210 can present information to the user such as a purchase approval or successful negotiation with the seller bot 250, a purchase denial or unsuccessful negotiation with the seller bot, reports describing the negotiation between the purchase bot and the seller bot, and so forth.

In one embodiment, the outcome of the purchase transaction and how it was accomplished can be printed or otherwise presented in a generated record. For example, a purchase receipt can indicate that a product was purchased and included an authorization for the user or was purchase by the bot without seeking user authorization.

As illustrated in FIG. 2, information can be retrieved by the seller bot 250 (and/or by the purchasing bot 210) from various information sources, including bank accounts, credit accounts, personal budgets. The source can be centralized, such as a centralized database, and/or can be de-centralized, such as multiple databases or multiple direct sources, such as a server managed by a bank or managed by a credit card company. In one embodiment, the source can be a database 235 managed by a service provider associated with communication services provided to the user 105 and/or managed by some entity associated with the purchasing bot 210 and/or the communication device 116 of the user. In another embodiment, the source can be a database 236 managed by an entity associated with the seller bot 250 and/or a retailer or manufacturer selling the product.

In one embodiment, the information retrieved by the seller bot 250 (and/or by the purchasing bot 210) can include brand loyalty, habitat, calendar, profile, habits, and/or preferences. In one embodiment, the habitat of the user 105 can be monitored or otherwise learned. The habitat is not limited to current presence of the user, and can include previous presence of the user. For example, the habitat can include places that the user has visited, frequently visits and/or is expected to visit. The information can be obtained from various sources, such as based on transactions of the user detected at the locations, calendar information indicating locations that will be or have been visited, GPS data indicating locations visited, and so forth. In one embodiment, the habitat can be generated to support local merchants of the user 105 or other objectives that are location-based.

In one embodiment, the purchasing bot 210 can receive input such as speech, text, data, time parameters (e.g., purchase now or place on wish list), purchase requests or guides (e.g. product specific or product general). These inputs can be processed by the purchasing bot 210 and utilized as part of the interaction between the purchasing bot and the seller bot 250.

In one embodiment, the purchasing bot 210 can apply buying rules or purchasing criteria during its interaction with the seller bot 250 or in processing information associated with a potential purchase. For example, the rules or criteria can be used for managing inbound offers from the seller bot 250, including filtering offers based on preferences, personal budget, consumer reviews, similar purchases by friends in a social network, brand loyalty, and so forth.

In one embodiment, other data, including third party data can be obtained which is associated with a product or products. For example, recommendations, recent purchases, or other data can be retrieved or otherwise obtained for friends or contacts of the user 105 that are in a social network of the user, such as an online social network. In another embodiment, other data, including consumer reviews, ratings and so forth that are generated by consumer review entities can be obtained and utilized by the purchasing bot 210 and/or the seller bot 250. In another embodiment, the purchasing bot 210 can deal with a retail website which may or may not have a seller bot 250. In one embodiment, the purchasing bot 210 can interface with a retail website after interacting with the seller bot 250 (such as a seller bot that is associated with a showroom where the user was reviewing a product). For example, the purchasing bot 210 can establish a communication session with the retail website following an unsuccessful negotiation with the purchasing bot 250. In one embodiment, offers or advertisements can be targeted to the purchasing bot 250 rather than being targeted to the user 105. For instance, information describing the purchasing bot can be provided to the seller bot so that the seller bot can select or otherwise generate product offers and product advertisements. In one embodiment, the information can be descriptive of the capabilities of the purchasing bot. In another embodiment, the information can be negotiations that the purchasing bot previously engaged in.

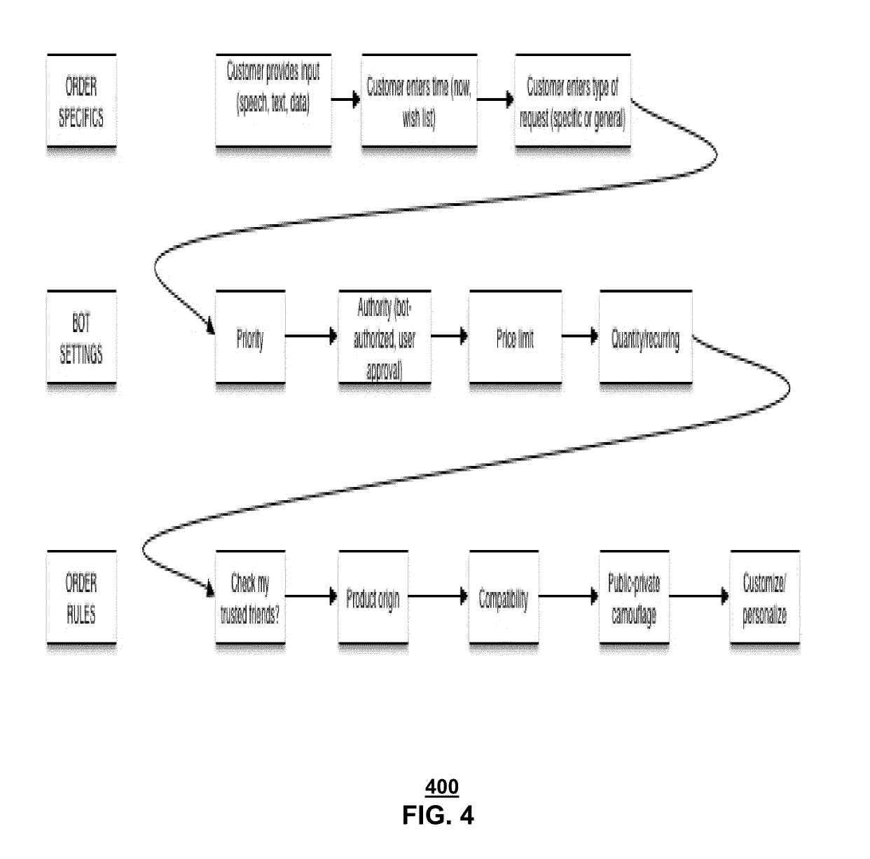

Referring to FIG. 4, data flow 400 is illustrated in which order specifics can include the user 105 providing input (e.g., speech, text and data) and entering timing parameters (e.g., immediate purchase or wishlist). The user can also enter the type of request, such as whether this is a general request (e.g., for a group of products that perform similar functions) or a specific request (e.g., for a specific product).

The information for the order specifics can then be provided or otherwise utilized for generating bot settings including prioritizing (e.g., types of products to be purchased, brands of products to be purchased, characteristics of the products to be weighted more heavily), authorization guidelines (e.g., user authorization required, bot recommendation to be provided, and/or bot authorized to make purchase without user review). The bot settings can also include specifying price limits, quantities of the products, and/or recurring purchases to be made.

The information for the bot settings and/or the order specifics can then be provided or otherwise utilized for generating order rules including checking trusted friends in a social network to determine if they have made a similar purchase or have made comments regarding any of the products. Product origin and compatibility with other equipment owned by the user 105 can be determined.

In one embodiment, a purchase or a negotiation for a purchase can be designated as public or private, such as where private is defined by the user (e.g., confidential so only the user has notice of the purchase or private so that only defined entities have knowledge of the purchase). The purchase or negotiation can also be camouflaged. For example, notification of the purchase can be anonymous so that an entity is made aware of the purchase or negotiation but the identity of the purchaser is withheld. As an example, a group within an online social network can be advised that a member of the social network is negotiating a purchase of a car (or has purchased the car) but the social network is not advised as to the identity of the purchaser. In another embodiment, notification can be camouflaged for some receiving entities, such as the group in the online social network, but not camouflaged for other receiving entities, such as individuals identified by the user as family.

In one embodiment, the order rules can include a specification (e.g., generated by the user 105 and/or generated by the purchasing bot 210) for customizing or personalizing a product, such as software installations, physical features, accessories, and so forth.

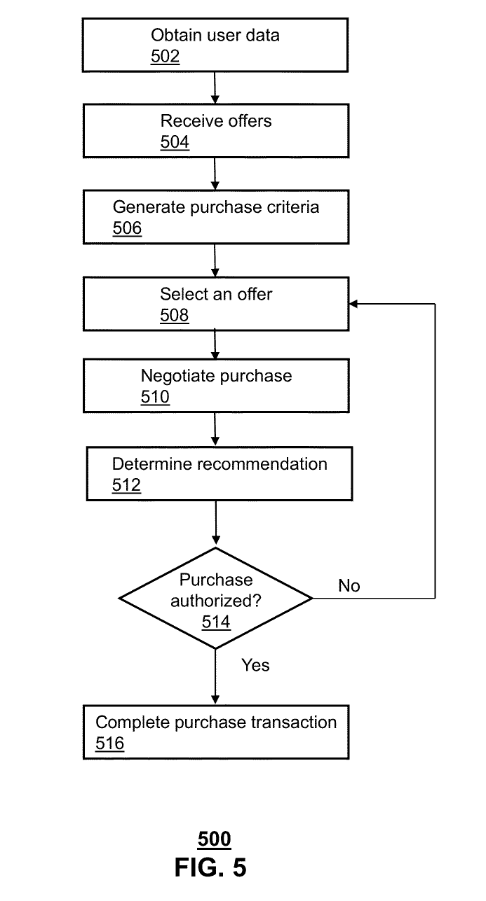

FIG. 5 depicts an illustrative embodiment of a method 500 used by system 100. Method 500 can begin at 502 where the bot 166 obtains user data of the user 105, such as financial information of the user, user preferences of the user, a history of purchase transactions of the user, a history of media consumption, preferences of other users that are part of an online social network with the user, a history of purchases of the other users, and so forth. At 504, the bot 166 can receive, from a server of a merchant (e.g., in a showroom or online), a group of offers for products. At 506, the bot 166 can analyze the user data to generate purchase criteria. The purchase criteria can take into account various factors including available funds of the user, available credit of the user, habits of the user, preferences of the user, brands purchased by the user, and so forth. At 508, the bot 166 can select an offer for a product from among the group of offers for the products according to the purchase criteria.

At 510, a negotiation between the bot 166 and the bot 168 of the server 130 (via an exchange of communications) can occur over a purchase of the product. The bot 166 can utilize the purchase criteria during the negotiation such as setting a price limit, a delivery time, obtaining bundled service(s) with the product, obtaining accessories for the product, and so forth. In one embodiment at 512, the bot 166 can determine or otherwise generate a recommendation associated with the purchase of the product based on the negotiating. For example, the user 105 can designate that all purchases require the bot 166 to receive user input from the user approving the purchase. After negotiating the details of the purchase transaction such as price, delivery, bundled services, accessories and so forth, the bot 166 generate the recommendation which can include information as to available funds/credit, budgets considerations, and/or other products that the user 105 needs or desires to purchase so that the user 105 can make an informed decision regarding the purchase transaction. If at 514 the purchase is authorized, then the bot 166 can complete the purchase transaction at 516 via communications with the bot 168 of the server 130, including providing payment information, delivery information and so forth to the server 130 or another device for finalizing the transaction.

In one embodiment, the receiving of the group of offers from the bot 168 can be in response to a determination (e.g., by the bot 168) that the communication device 116 has entered the showroom 102. In one embodiment, the bot 166 can receive a product request prior to receiving the group of offers for the products from the bot 168, where the product request is generated by an appliance of the user, and where the selecting of the offer for the product from among the group of offers for the products is based in part on the product request.

In one embodiment, the bot 166 can receive a product request prior to receiving the group of offers for the products from the bot 168, where the product request is generated by a vehicle communication system of the user 105, and where the selecting of the offer for the product from among the group of offers for the products is based in part on the product request.

In one embodiment, the bot 166 can obtain a group of advertisements for other products and can store the group of advertisements. The user data can be analyzed by the bot 166 to generate advertisement criteria. User activity can be monitored by the bot 166 and a selection of a target advertisement from among the group of advertisements according to the advertisement criteria and the user activity can be performed. The bot 166 can present the target advertisement.

In one embodiment, the bot 166 can provide a presentation message to an advertisement server associated with the target advertisement to indicate that the target advertisement has been presented by the communication device. In one embodiment, the bot 166 can obtain a history of purchases of other users, such as where the user and the other users are part of an online social network. In this example, the selecting of the offer for the product by bot 166 can be according to the history of purchases of the other users. In another embodiment, the generation of the group of offers for the products by the bot 168 can be based on the history of purchases of other users. For instance, the bot 166 can share this information with the bot 168. In one embodiment, the bot 166 can receive or otherwise access available funds data associated with a bank account of the user and can receive or otherwise access available credit data associated with a credit account of the user. The access to this financial data by the bot 166 can be controlled by the user 105, such as requiring authorization for each access attempt or obtaining a pre-authorization for particular accounts from the user 105. In one embodiment, the user data can include a history of media consumption by the user 105 associated with a group of end user devices of the user which may or may not have bots 166 resident thereon.

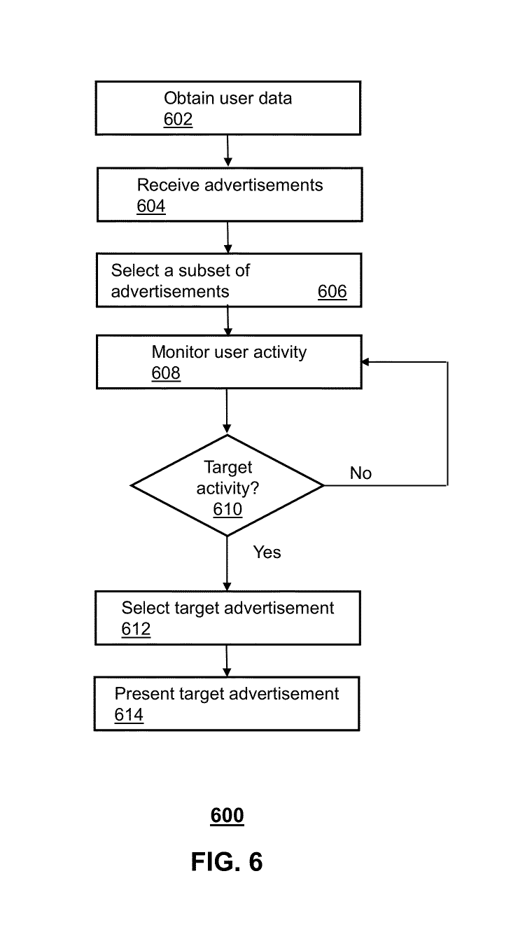

FIG. 6 depicts an illustrative embodiment of a method 600 used by system 100. Method 600 can begin at 602 where user data is obtained by the bot operating on the user's communication device, such as bot 166 of communication device 116 of FIG. 1. The user data can be from various sources and of various types including financial information of the user (e.g., band account data of available funds, credit card data of available credit, a personal budget, spending limits and so forth), user preferences of the user (e.g., from a user profile and/or from monitored behavior of the user such as media consumption), and/or a history of purchase transactions of the user. At 604, a plurality of advertisements can be received by the bot 166. At 606, a group of advertisements can be selected by the bot 166 from among the plurality of advertisements, such as according to all or a portion of the user data. The selected group of advertisements can be stored by the bot 166 (e.g., locally in a memory of the communication device 116 and/or remotely in a memory of another device such as a digital video recorder). Non-selected advertisements of the plurality of advertisements can be deleted or otherwise discarded from the memory.

At 608, the bot 166 can monitor user activity at the communication device 116, such as presentation of videos, visiting websites, and so forth. Other user activities associated with other user devices can also be monitored, such as presentation of video at a television which is detected by the bot 166. At 610, a determination can be made as to whether target user activity is occurring according to the monitoring of the user activity. For example, target user activity can be user activity at the communication device 116 which is appropriate for presentation of one of the selected advertisements, such as presenting an advertisement for a vacation to Hawaii during a presentation of a video that is describing Hawaii.

If it is determined that target user activity is occurring, then at 612 a target advertisement can be selected by the bot 166 from among the selected group of advertisements. The selection of the target advertisement can be based on advertisement criteria (such as generated by the bot 166 from the user data) and the target user activity. The advertisement criteria can include information indicating that a particular advertisement presented during a particular user activity has a higher than average success rate with respect to the user purchasing the product being advertised. At 614, the selected target advertisement can be presented by the bot 166 at the communication device 116 during the target activity. In one embodiment, the receiving of the plurality of advertisements by the bot 166 can be in response to a determination by the bot 168 that the communication device 116 is in the showroom 102, where the plurality of advertisements can be associated with the products 125 sold in the showroom.

In one embodiment, the bot 166 or the bot 168 can provide data to a display device of the showroom 102 to cause the display device to present information related to the products 125, including an advertisement, a consumer review, reviews by other users that purchased the product where the other users are in an online social network of the user. In one embodiment, the bot 168 of server 130 can provide metadata to the online server 150 to describe an interaction of the user 105 at the showroom 102 associated with the product. In one embodiment, a determination can be made that the user 105 has purchased the product 125 from the online entity and the bot 168 can engage in revenue sharing with the online entity according to a purchase transaction for the product. In one embodiment, the product 125 can be adjusted to generate an adjusted product according to the interaction data.

In one embodiment, the user data can include user preferences according to user input, a transaction history of the user, a media consumption history of the user, demographics of the user, or a combination thereof. In one embodiment, the bot 166 can provide bundling data to the bot 168 to enable a determination of bundling offers that describe services associated with the product, such as where the services are provided by different third parties. For example, the bundling data can include current services of the user 105 that are associated with the product 125 and contract information for those services. From this information, the bot 168 can determine whether the current services can be transferred to the product 125 or whether the contract can be bought out so that new services of a new entity can be bundled with the product 125.

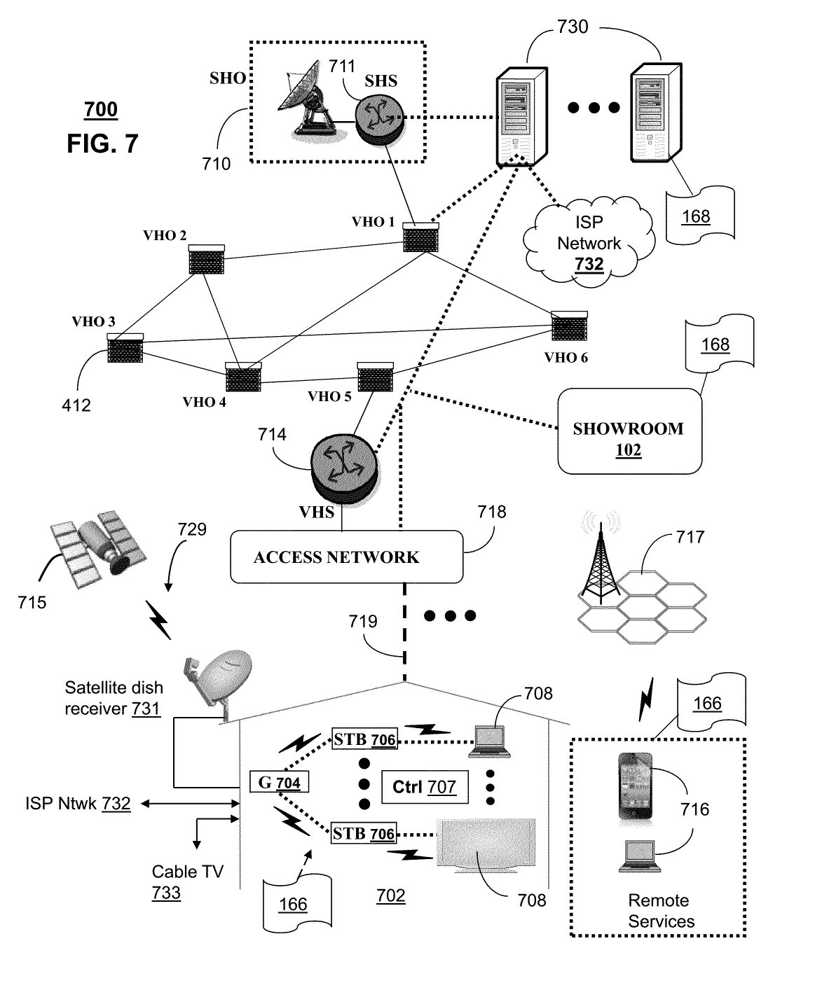

FIG. 7 depicts an illustrative embodiment of a communication system 700 for providing communication services that include facilitating purchases or products and services, as well as enabling voice, video, data and messaging services. The communication system 700 can represent an Internet Protocol Television (IPTV) media system. Communication system 700 can be overlaid or operably coupled with the devices and systems of FIG. 1 as another representative embodiment of communication system 700. For instance, one or more devices illustrated in the communication system 700 of FIG. 7 can enable detecting a communication device of a user in a showroom; responsive to the detecting, receiving, from the communication device, user preferences of the user and a history of purchase transactions of the user; selecting a group of offers for products from among a plurality of offers for a plurality of products according to the user preferences and the history of purchase transactions; determining an availability for the products; providing, to the communication device, the group of offers for the products according to the availability; receiving, from the communication device, a selection message indicating an offer for a product that was selected by the communication device from among the group of offers for the products; negotiating, with the communication device via an exchange of communications, a purchase of the product; and/or communicating, with the communication device, to complete a purchase transaction for the product.

One or more devices illustrated in the communication system 700 can also enable obtaining user data of the user, where the user data comprises financial information of the user, user preferences of the user, and/or a history of purchase transactions of the user; receiving a plurality of advertisements; selecting a group of advertisements from among the plurality of advertisements according to the user data; storing the group of advertisements and deleting non-selected advertisements of the plurality of advertisements; analyzing the user data to generate advertisement criteria; monitoring user activity at the communication device; determining target user activity according to the monitoring of the user activity; selecting a target advertisement from among the group of advertisements according to the advertisement criteria and the target user activity; and/or presenting the target advertisement during the target user activity.

The IPTV media system can include a super head-end office (SHO) 710 with at least one super headend office server (SHS) 711 which receives media content from satellite and/or terrestrial communication systems. In the present context, media content can represent, for example, audio content, moving image content such as 2D or 3D videos, video games, virtual reality content, still image content, and combinations thereof. The SHS server 711 can forward packets associated with the media content to one or more video head-end servers (VHS) 714 via a network of video head-end offices (VHO) 712 according to a multicast communication protocol.

The VHS 714 can distribute multimedia broadcast content via an access network 718 to commercial and/or residential buildings 702 housing a gateway 704 (such as a residential or commercial gateway). The access network 718 can represent a group of digital subscriber line access multiplexers (DSLAMs) located in a central office or a service area interface that provide broadband services over fiber optical links or copper twisted pairs 719 to buildings 702. The gateway 704 can use communication technology to distribute broadcast signals to media processors 706 such as Set-Top Boxes (STBs) which in turn present broadcast channels to media devices 708 such as computers or television sets managed in some instances by a media controller 707 (such as an infrared or RF remote controller).

The gateway 704, the media processors 706, and media devices 708 can utilize tethered communication technologies (such as coaxial, powerline or phone line wiring) or can operate over a wireless access protocol such as Wireless Fidelity (WiFi), Bluetooth®, Zigbee®, or other present or next generation local or personal area wireless network technologies. By way of these interfaces, unicast communications can also be invoked between the media processors 706 and subsystems of the IPTV media system for services such as video-on-demand (VoD), browsing an electronic programming guide (EPG), or other infrastructure services.

A satellite broadcast television system 729 can be used in the media system of FIG. 7. The satellite broadcast television system can be overlaid, operably coupled with, or replace the IPTV system as another representative embodiment of communication system 700. In this embodiment, signals transmitted by a satellite 715 that include media content can be received by a satellite dish receiver 731 coupled to the building 702. Modulated signals received by the satellite dish receiver 731 can be transferred to the media processors 706 for demodulating, decoding, encoding, and/or distributing broadcast channels to the media devices 708. The media processors 706 can be equipped with a broadband port to an Internet Service Provider (ISP) network 732 to enable interactive services such as VoD and EPG as described above.

In yet another embodiment, an analog or digital cable broadcast distribution system such as cable TV system 733 can be overlaid, operably coupled with, or replace the IPTV system and/or the satellite TV system as another representative embodiment of communication system 700. In this embodiment, the cable TV system 733 can also provide Internet, telephony, and interactive media services.

The subject disclosure can apply to other present or next generation over-the-air and/or landline media content services system.

Some of the network elements of the IPTV media system can be coupled to one or more computing devices 730, a portion of which can operate as a web server for providing web portal services over the ISP network 732 to wireline media devices 708 or wireless communication devices 716.

Communication system 700 can also provide for all or a portion of the computing devices 730 to function as bot 168 (herein referred to as server 730). The server 730 can use computing and communication technology to perform function 168, which can include among other things, detecting a communication device of a user in a showroom; responsive to the detecting, receiving, from the communication device, user preferences of the user and a history of purchase transactions of the user; selecting a group of offers for products from among a plurality of offers for a plurality of products according to the user preferences and the history of purchase transactions; determining an availability for the products; providing, to the communication device, the group of offers for the products according to the availability; receiving, from the communication device, a selection message indicating an offer for a product that was selected by the communication device from among the group of offers for the products; negotiating, with the communication device via an exchange of communications, a purchase of the product; and/or communicating, with the communication device, to complete a purchase transaction for the product

In another embodiment, the media processors 706 and wireless communication devices 716 can be provisioned with software functions 166 (bot 166), respectively, to utilize the services of server 730. Bot 166 enables filtering of product offers and advertisements from the bot 168. As another example, function 166 of media processors 706 and wireless communication devices 716 enable user data to be collected and analyzed by the server 730. For instance, a device activity state of the communication device 716 can be transmitted to the server 730 to facilitate a determination as to whether the user is showrooming in the showroom 102. As yet another example, media consumption data can be monitored for a user (e.g., at the user's residence) and this data (or a portion thereof depending on permissions provided by the user) can be provided to the server 730 for analysis to determine a group of products that can be offered to the bot 166 when the user is in the showroom seeking to purchase a product.

Multiple forms of media services can be offered to media devices over landline technologies such as those described above. Additionally, media services can be offered to media devices by way of a wireless access base station 717 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless access network technologies can be used in one or more embodiments of the subject disclosure.

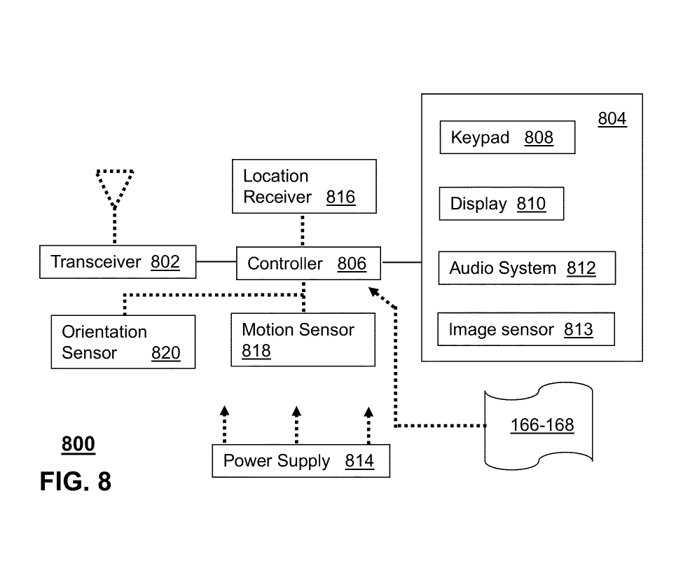

FIG. 8 depicts an illustrative embodiment of a communication device 800. Communication device 800 can serve in whole or in part as an illustrative embodiment of the devices depicted in FIGS. 1, 2 and 7 and can be configured to perform portions of methods 300-600. Communication device 800 can perform a number of operations including obtaining user data of the user, where the user data comprises financial information of the user, user preferences of the user, and/or a history of purchase transactions of the user; receiving a plurality of advertisements; selecting a group of advertisements from among the plurality of advertisements according to the user data; storing the group of advertisements and deleting non-selected advertisements of the plurality of advertisements; analyzing the user data to generate advertisement criteria; monitoring user activity at the communication device; determining target user activity according to the monitoring of the user activity; selecting a target advertisement from among the group of advertisements according to the advertisement criteria and the target user activity; and/or presenting the target advertisement during the target user activity.

In one or more embodiments, the communication device 800 can receive (e.g., from a server of a merchant) a group of offers for products; analyze the user data to generate purchase criteria; select an offer for a product from among the group of offers for the products according to the purchase criteria; negotiate, with the server via an exchange of communications, a purchase of the product, where the negotiating is according to the purchase criteria; determine a recommendation associated with the purchase of the product based on the negotiating; present the recommendation; obtain an authorization for the purchase of the product in response to the recommendation; and/or communicate, with the server, to complete a purchase transaction for the product in response to the authorization. In one embodiment, the receiving of the plurality of advertisements can be in response to a determination by the server that the communication device is in a showroom associated with the server, and the plurality of advertisements can be associated with products sold in a showroom. In one embodiment, the communication device 800 can provide, to the server, the user preferences of the user and the history of purchase transactions of the user; and can receive, from the server, a group of offers for products that are selected by the server according to the user preferences and the history of purchase transactions. In one embodiment, the communication device 800 can detect that a purchase transaction for a product in the showroom has not been completed and can, in response to the purchase transaction not being completed, provide interaction data descriptive of the purchase transaction to a second server that manages a website of an online merchant selling the product.

Communication device 800 can comprise a wireline and/or wireless transceiver 802 (herein transceiver 802), a user interface (UI) 804, a power supply 814, a location receiver 816, a motion sensor 818, an orientation sensor 820, and a controller 806 for managing operations thereof. The transceiver 802 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 802 can also be adapted to support circuit-switched wireline access technologies (such as PSTN), packet-switched wireline access technologies (such as TCP/IP, VoIP, etc.), and combinations thereof.

The UI 804 can include a depressible or touch-sensitive keypad 808 with a navigation mechanism such as a roller ball, a joystick, a mouse, or a navigation disk for manipulating operations of the communication device 800. The keypad 808 can be an integral part of a housing assembly of the communication device 800 or an independent device operably coupled thereto by a tethered wireline interface (such as a USB cable) or a wireless interface supporting for example Bluetooth®. The keypad 808 can represent a numeric keypad commonly used by phones, and/or a QWERTY keypad with alphanumeric keys. The UI 804 can further include a display 810 such as monochrome or color LCD (Liquid Crystal Display), OLED (Organic Light Emitting Diode) or other suitable display technology for conveying images to an end user of the communication device 800. In an embodiment where the display 810 is touch-sensitive, a portion or all of the keypad 808 can be presented by way of the display 810 with navigation features.

The display 810 can use touch screen technology to also serve as a user interface for detecting user input. As a touch screen display, the communication device 800 can be adapted to present a user interface with graphical user interface (GUI) elements that can be selected by a user with a touch of a finger. The touch screen display 810 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 810 can be an integral part of the housing assembly of the communication device 800 or an independent device communicatively coupled thereto by a tethered wireline interface (such as a cable) or a wireless interface.

The UI 804 can also include an audio system 812 that utilizes audio technology for conveying low volume audio (such as audio heard in proximity of a human ear) and high volume audio (such as speakerphone for hands free operation). The audio system 812 can further include a microphone for receiving audible signals of an end user. The audio system 812 can also be used for voice recognition applications. The UI 804 can further include an image sensor 813 such as a charged coupled device (CCD) camera for capturing still or moving images.

The power supply 814 can utilize common power management technologies such as replaceable and rechargeable batteries, supply regulation technologies, and/or charging system technologies for supplying energy to the components of the communication device 800 to facilitate long-range or short-range portable applications. Alternatively, or in combination, the charging system can utilize external power sources such as DC power supplied over a physical interface such as a USB port or other suitable tethering technologies.

The location receiver 816 can utilize location technology such as a global positioning system (GPS) receiver capable of assisted GPS for identifying a location of the communication device 800 based on signals generated by a constellation of GPS satellites, which can be used for facilitating location services such as navigation. The motion sensor 818 can utilize motion sensing technology such as an accelerometer, a gyroscope, or other suitable motion sensing technology to detect motion of the communication device 800 in three-dimensional space. The orientation sensor 820 can utilize orientation sensing technology such as a magnetometer to detect the orientation of the communication device 800 (north, south, west, and east, as well as combined orientations in degrees, minutes, or other suitable orientation metrics).

The communication device 800 can use the transceiver 802 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 806 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 800.

Other components not shown in FIG. 8 can be used in one or more embodiments of the subject disclosure. For instance, the communication device 800 can include a reset button (not shown). The reset button can be used to reset the controller 806 of the communication device 800. In yet another embodiment, the communication device 800 can also include a factory default setting button positioned, for example, below a small hole in a housing assembly of the communication device 800 to force the communication device 800 to re-establish factory settings. In this embodiment, a user can use a protruding object such as a pen or paper clip tip to reach into the hole and depress the default setting button. The communication device 800 can also include a slot for adding or removing an identity module such as a Subscriber Identity Module (SIM) card. SIM cards can be used for identifying subscriber services, executing programs, storing subscriber data, and so forth.

The communication device 800 as described herein can operate with more or less of the circuit components shown in FIG. 8. These variant embodiments can be used in one or more embodiments of the subject disclosure. The communication device 800 can be adapted to perform the functions of the devices of FIGS. 1 and 4, such as the communication device 116, the server 130, the database 135, the server 150, the server 430, the bots 210, 250, and so forth. In addition, the controller 806 can be adapted in various embodiments to perform the bot functions 166-168, respectively.

Upon reviewing the aforementioned embodiments, it would be evident to an artisan with ordinary skill in the art that said embodiments can be modified, reduced, or enhanced without departing from the scope of the claims described below. For example, the bot 166 can be in a distributed environment with a master-slave relationship where a first computing device of the user 105 (e.g., a desktop computer at a residence of the user) acts as the master and where a group of other devices (e.g., communication device 116) act as the slaves.

In one embodiment, access to user data by the bot 168 can be limited to only after a determination is made that the user is seeking to purchase a particular product. In another embodiment, access to the user data can be responsive to identifying the presence of the user in the showroom. In on embodiment, purchases by individuals in a social network of the user of similar products (at the showroom or elsewhere) can be detected so that the sales agent (e.g., human or virtual) can present this information to the user. Other embodiments can be used in the subject disclosure.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

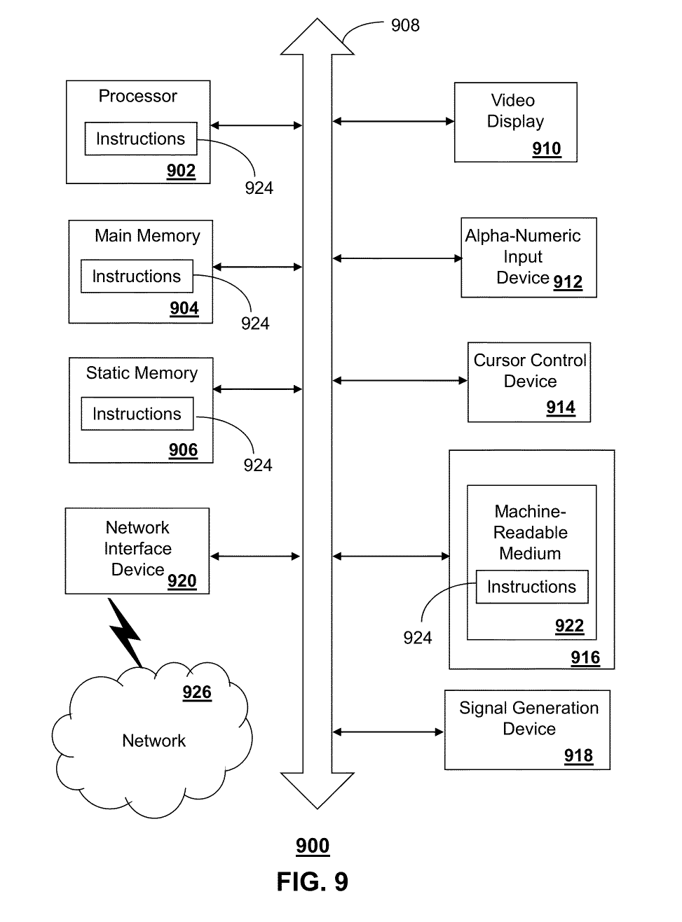

FIG. 9 depicts an exemplary diagrammatic representation of a machine in the form of a computer system 900 within which a set of instructions, when executed, may cause the machine to perform any one or more of the methods described above. One or more instances of the machine can operate, for example, as the communication device 116, the server 130 or the server 150 to facilitate a purchase of a product by a user, such as via bot interaction. In some embodiments, the machine may be connected (e.g., using a network 926) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 900 may include a processor (or controller) 902 (e.g., a central processing unit (CPU)), a graphics processing unit (GPU, or both), a main memory 904 and a static memory 906, which communicate with each other via a bus 908. The computer system 900 may further include a display unit 910 (e.g., a liquid crystal display (LCD), a flat panel, or a solid state display). The computer system 900 may include an input device 912 (e.g., a keyboard), a cursor control device 914 (e.g., a mouse), a disk drive unit 916, a signal generation device 918 (e.g., a speaker or remote control) and a network interface device 920. In distributed environments, the embodiments described in the subject disclosure can be adapted to utilize multiple display units 910 controlled by two or more computer systems 900. In this configuration, presentations described by the subject disclosure may in part be shown in a first of the display units 910, while the remaining portion is presented in a second of the display units 910.

The disk drive unit 916 may include a tangible computer-readable storage medium 922 on which is stored one or more sets of instructions (e.g., software 924) embodying any one or more of the methods or functions described herein, including those methods illustrated above. The instructions 924 may also reside, completely or at least partially, within the main memory 904, the static memory 906, and/or within the processor 902 during execution thereof by the computer system 900. The main memory 904 and the processor 902 also may constitute tangible computer-readable storage media.

Dedicated hardware implementations including, but not limited to, application specific integrated circuits, programmable logic arrays and other hardware devices can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 922 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure. The term “non-transitory” as in a non-transitory computer-readable storage includes without limitation memories, drives, devices and anything tangible but not a signal per se.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth®, WiFi, Zigbee®), and long-range communications (e.g., WiMAX, GSM, CDMA, LTE) can be used by computer system 900.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, can be used in the subject disclosure. In one or more embodiments, features that are positively recited can also be excluded from the embodiment with or without replacement by another component or step. The steps or functions described with respect to the exemplary processes or methods can be performed in any order. The steps or functions described with respect to the exemplary processes or methods can be performed alone or in combination with other steps or functions (from other embodiments or from other steps that have not been described).

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, application specific integrated circuit, and/or programmable gate array including a Field PGA. In one or more embodiments, when a processor executes instructions to perform “operations”, this can include the processor performing the operations directly and/or facilitating, directing, or cooperating with another device or component to perform the operations.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
obtaining, by a communication device of a user that includes a processor, user data of the user, wherein the user data comprises financial information of the user, user preferences of the user, and a history of purchase transactions of the user;
receiving, by the communication device from a server of a merchant, a group of offers for products;
analyzing, by the communication device, the user data to generate purchase criteria;
selecting, by the communication device, an offer for a product from among the group of offers for the products according to the purchase criteria;
negotiating, by the communication device with the server via an exchange of communications, a purchase of the product, wherein the negotiating by the communication device is according to the purchase criteria;
determining, by the communication device, a recommendation associated with the purchase of the product based on the negotiating;
presenting, by the communication device, the recommendation;
obtaining, by the communication device, an authorization for the purchase of the product in response to the recommendation; and
communicating, by the communication device with the server, to complete a purchase transaction for the product in response to the authorization.

2. The method of claim 1, wherein the receiving of the group of offers is in response to a determination that the communication device has entered a showroom associated with the products, wherein the financial information comprises a spending budget of the user, wherein the authorization comprises user input received at the communication device, and further comprising generating and providing a notification that describes the purchase transaction and does not describe an identity of the user.

3. The method of claim 2, comprising receiving, by the communication device, a product request prior to receiving the group of offers for the products from the server, wherein the product request is generated by an appliance of the user, and wherein the selecting of the offer for the product from among the group of offers for the products is based in part on the product request.

4. The method of claim 1, comprising receiving, by the communication device, a product request prior to receiving the group of offers for the products from the server, wherein the product request is generated by a vehicle communication system of the user, wherein the selecting of the offer for the product from among the group of offers for the products is based in part on the product request, wherein the group of offers for the products include a price for the products and a description of the products, and wherein the negotiating for the purchase of the product includes exchanging price proposals and price counterproposals.

5. The method of claim 1, comprising:
obtaining, by the communication device, a group of advertisements for other products;
storing, by the communication device, the group of advertisements;
analyzing, by the communication device, the user data to generate advertisement criteria;
monitoring, by the communication device, user activity at the communication device;
selecting, by the communication device, a target advertisement from among the group of advertisements according to the advertisement criteria and the user activity; and
presenting, by the communication device, the target advertisement.

6. The method of claim 5, comprising:
receiving, by the communication device, a plurality of advertisements; and
selecting, by the communication device, the group of advertisements from among the plurality of advertisements according to the user data.

7. The method of claim 5, comprising:
providing, by the communication device, a presentation message to an advertisement server associated with the target advertisement to indicate that the target advertisement has been presented by the communication device.

8. The method of claim 1, wherein the server of the merchant manages a website of the merchant, and further comprising:
obtaining, by the communication device, a history of purchases of other users, wherein the user and the other users are part of an online social network, and wherein the selecting of the offer for the product is according to the history of purchases of the other users.

9. The method of claim 1, wherein the obtaining of the user data of the user comprises:
receiving, by the communication device, available funds data associated with a bank account of the user; and
receiving, by the communication device, available credit data associated with a credit account of the user.

10. The method of claim 1, wherein the user data comprises a history of media consumption by the user associated with a group of end user devices of the user, and further comprising:
providing a record indicating that the authorization for the purchase of the product was obtained.

11. A server comprising:
a processor; and
a memory that stores executable instructions that, when executed by the processor, facilitate performance of operations, comprising:
detecting a communication device of a user in a showroom;
responsive to the detecting, receiving, from the communication device, user preferences of the user and a history of purchase transactions of the user;
selecting a group of offers for products from among a plurality of offers for a plurality of products according to the user preferences and the history of purchase transactions;
determining an availability for the products;
providing, to the communication device, the group of offers for the products according to the availability;
receiving, from the communication device, a selection message indicating an offer for a product that was selected by the communication device from among the group of offers for the products;
negotiating, with the communication device via an exchange of communications, a purchase of the product; and
communicating, with the communication device, to complete a purchase transaction for the product.

12. The server of claim 11, wherein the operations further comprise:
selecting a group of services from among a plurality of services associated with the product according to the user preferences and the history of purchase transactions; and
providing, to the communication device, offers for the group of services, wherein the selection message indicates a service that was selected by the communication device from among the group of services, wherein the negotiating is associated with a purchase of the service, and wherein the communicating with the communication device completes a purchase transaction for the service.

13. The server of claim 11, wherein the operations further comprise:
in response to a completion of the purchase transaction of the product, deleting the user preferences of the user and the history of purchase transactions of the user.

14. The server of claim 11, wherein the operations further comprise:
detecting that the purchase transaction for the product has not been completed; and
in response to the purchase transaction not being completed, providing interaction data descriptive of the purchase transaction to a second server that manages a website of an online merchant selling the product, the online merchant being different from an entity managing the showroom.

15. The server of claim 14, wherein the operations further comprise receiving revenue sharing from the online merchant responsive to a purchase of the product by the user from the online merchant.

16. A machine-readable storage device, comprising executable instructions that, when executed by a processor of a communication device of a user, facilitate performance of operations of a purchasing bot, the operations comprising:
providing purchasing bot data to a server, wherein the purchasing bot data includes information describing the purchasing bot;
receiving a plurality of advertisements from the server that are selected according to the purchasing bot data;
selecting a group of advertisements from among the plurality of advertisements;
storing the group of advertisements and deleting non-selected advertisements of the plurality of advertisements; and
presenting a target advertisement from among the group of advertisements.

17. The machine-readable storage device of claim 16, wherein the operations further comprise:
obtaining user data of the user, wherein the user data comprises financial information of the user, user preferences of the user, and a history of purchase transactions of the user,
wherein the selecting of the group of advertisements from among the plurality of advertisements is based on the user data, and
wherein the information describing the purchasing bot includes capabilities of the purchasing bot and past negotiations managed by the purchasing bot.

18. The machine-readable storage device of claim 17, wherein the operations further comprise:
analyzing the user data to generate advertisement criteria;
monitoring user activity at the communication device;
determining target user activity according to the monitoring of the user activity; and
selecting the target advertisement from among the group of advertisements according to the advertisement criteria and the target user activity.

19. The machine-readable storage device of claim 16, wherein the operations further comprise:
receiving, from a server of a merchant, a group of offers for products;
analyzing user data to generate purchase criteria;
selecting an offer for a product from among the group of offers for the products according to the purchase criteria;
negotiating, with the server via an exchange of communications, a purchase of the product, wherein the negotiating is according to the purchase criteria;
determining a recommendation associated with the purchase of the product based on the negotiating;
presenting the recommendation;
obtaining an authorization for the purchase of the product in response to the recommendation; and
communicating, with the server, to complete a purchase transaction for the product in response to the authorization.

20. The machine-readable storage device of claim 16, wherein the receiving of the plurality of advertisements is in response to a determination that the communication device is in a showroom associated with the server, wherein the plurality of advertisements are associated with products sold in the showroom, and wherein the plurality of advertisements selected according to the purchasing bot data are selected based on a determination of a likelihood that the purchasing bot will recommend purchasing products associated with the plurality of advertisements, wherein the determination of the likelihood is based on past negotiations managed by the purchasing bot.
